(19) United States
(12) Patent Application Publication
(10) Pub. No.: US 2011/0256504 A1
(43) Pub. Date: Oct. 20, 2011

(54) Safe egde IPR disk

(76) Inventor: Robert T. Rudman, Denver, CO (US)

(21) Appl. No.: 12/799,143

(22) Filed: Apr. 20, 2010

(51) Int. Cl. A61C 3/06

(52) U.S. Cl. 433/166

(57) ABSTRACT

The present invention relates to a dental safe edge interproximal disk for stripping the interproximal contact area of adjacent teeth wherein an abrasively coated circular disk has an uncoated periphery which facilitates the initial entry of the disk between the contact points.

### FIELD OF INVENTION

The present invention is directed to a safe edge abrasively coated dental interproximal reduction disk for removing enamel from the interproximal contact surfaces of adjacent teeth.

### BACKGROUND OF THE INVENTION

Orthodontic procedures for straightening teeth most frequently involve aligning crowded teeth. Crowding of the teeth may be eliminated by expanding the dental arches buccally, labially, moving the teeth distally in the arch and narrowing the teeth at their interproximal contact points. The present invention involves narrowing, or stripping, teeth at their interproximal contact points. Another reason for stripping the interproximal contact points is to flatten the contact points, especially the lower anterior teeth. The theory is the lower anterior teeth are less likely to re-crowd if the adjacent interproximal contacts are flat rather than a ball contact. An additional purpose for flattening the contact points is in situations where there is a gingival interproximal space. The flattening of the contact points allows the teeth to be brought closer together which closes the gingival interproximal spacing. A further reason is to narrow certain teeth where there is a tooth size discrepancy between the upper and lower teeth.

The interproximal contact points of teeth have been re-shaped with dental disks and dental drills. Dental disks with an abrasive coated disk have been described in patents: 0302952/A August, 1884, Smith: 0336695N/A February 1886, Byers; 0478881N/A July 1892, Moore; 1355888 October 1920 1930 Stratford; 2991596 July 1961,Walters; 3239971 March 1966 Freerks et al.; 3307300 March 1967 Field; 3562968 February 1971 Johnson et al.; 3789462 February 1974, Reich; 3858368 January 1975, Cocherell et al.; 3883998 May 1975, Dosser; 4055897 November 1977, Brix and 4185388 January 1980, Jarby. Smith invented a paper disk coated with an abrasive screw-mounted to a mandrel. Byers disclosed a flexible abrasive disk. Moore invented a snap fitting between the disk and the mandrel. Parks disclosed a cellulose disk with a thinner abrasively coated periphery. Brix also discloses a thinner periphery which is coated with an abrasive. In summary, the prior art disks are coated to their peripheral edges.

Variations of the rotary disks have included a thin metal disk coated with abrasives such as diamond chips. The abrasive coatings have been on one side of the disk or both sides of the disk. In all applications the abrasive coatings have extended to the peripheral edge of the disk. These coated metal disks have been most adaptable to interproximal stripping of adjacent teeth due to their strength and inherent thinness. As the dental handpiece rotates the disk this disk is placed vertically between adjacent teeth contact points and enamel on one or both contact points is removed. The initial entry of the disk between the contact is often difficult due to the fact the periphery of the disk has the abrasive coating which adds thickness to the disk and creates a resistance to the disk passing between the contact points. The result is occasionally one of the teeth is notched rather than reduced at its interproximal contact point.

### SUMMARY OF THE INVENTION

The present invention is directed to a planar circular dental sanding disk with at least one of the planar surfaces coated with an abrasive. The periphery of the planar disk is not coated. The disk has a radial center wherein a rod-like mandrel is attached at a right angle to the disk planar surface. The disk may be removably or permanently attached to the mandrel. The removable attachments may be with a screw or a variety of quick-couples. The free end of the mandrel is mounted to a dental hand piece which provides rotary motion to the disk. The disk in an ideal form is a thin metal and the abrasive is composed of fine diamond chips. The thin uncoated periphery of the disk planar surface slides into the interproximal contact area of adjacent teeth. The uncoated periphery of the disk passes between adjacent interproximal contact points with the ease of dental floss. As the disk rotates the disk further penetrates the contact point until the abrasive part of the disk surface sands the contact point or points of the teeth. The disk may have the inside or outside surfaces of the disk abrasively coated, or both surfaces coated. The coated part of the disk may be solid or perforated. The disk ranges in thickness from 0.1 mm in 0.1 mm increments to as much as 3 mm. The most ideal thickness for interproximal contact points would be the thinnest. Metal disks coated with diamond adhesive are the most ideal for sterilizing by autoclave. The disk material is not limited to metal as other materials are available with similar physical characteristics. The disk diameters range from 10 mm. to 30 mm. Disk thickness ranges from 0.1 mm to 0.3 mm.

### BRIEF DESCRIPTION OF THE DRAWINGS

FIG. 1 is a perspective view of the safe-edge IPR disk mounted on a mandrel which is mounted to dental handpiece;

FIG. 2 is a perspective view of the safe-edge IPR disk in the interproximal contact area of adjacent teeth;

FIG. 3 is a view of the safe-edge IPR disk;

FIG. 4 is a perspective view of the safe-edge IPR disk with an abrasive coating on the side of the disk adjacent to the attached mandrel;

FIG. 5 is a perspective view of the safe-edge IPR disk with an abrasive coating on the side of the disk opposite to the attached mandrel;

FIG. 6 is a view of the safe-edge IPR disk with an perforated disk;

FIG. 7 is a perspective view of the safe-edge IPR disk wherein the disk is integral with the attached mandrel;

FIG. 8 is a perspective view of the safe-edge IPR disk is removably attached to the mandrel with a screw; and

FIG. 9 is a perspective view of the safe-edge IPR disk is removably attached to the mandrel with a quick-couple.

### DETAILED DESCRIPTION OF THE INVENTION

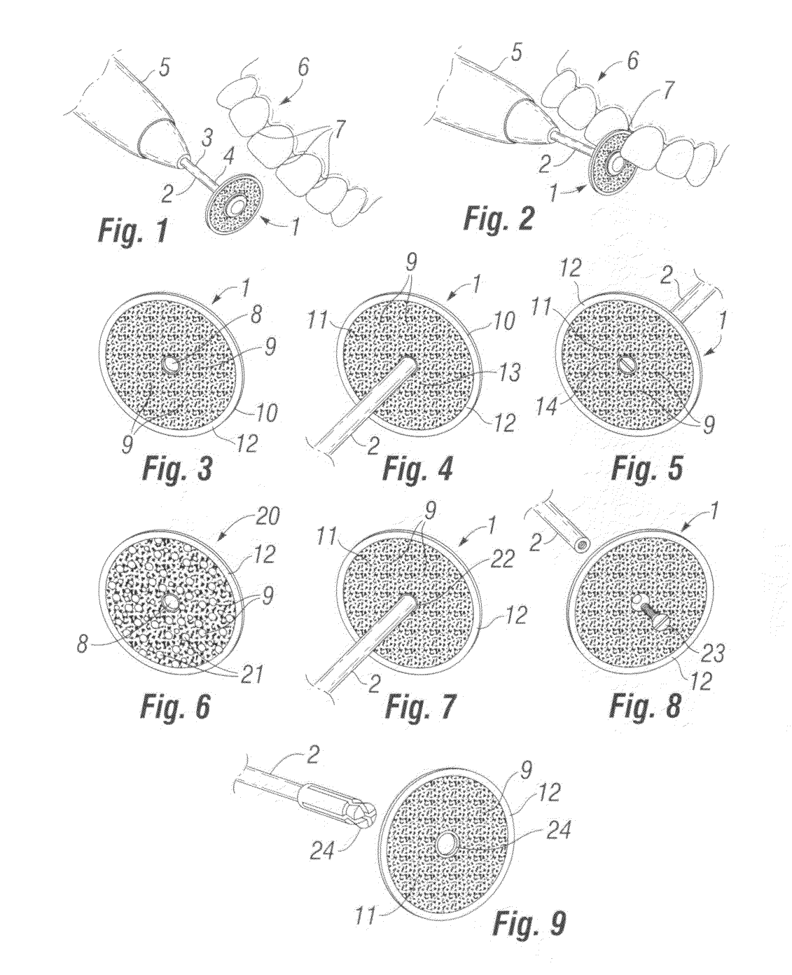

The present invention relates to a safe edge IPR (interproximal reduction) disk used for reducing the interproximal areas between contacting adjacent teeth, more specifically, reduction of adjacent contact points. The disk is designed in a manner that the initial entry of the disk between the contact points is by a thin uncoated periphery of the disk. The entry of the uncoated disk between the contact points is with the same ease that dental floss would enter the contact point, thus preventing inadvertent notching of the teeth that can be caused by disks fully coated to their peripheral edge. FIG. 1 discloses a safe edge IPR disk 1 connected to a dental mandrel 2, with a driving end 3 and a working end 4, which is mounted to a dental handpiece 5. The safe edge IPR disk 1 is adjacent to a patient's anterior teeth 6 in preparation to stripping of the interproximal contact points 7 of the anterior teeth 6.

In FIG. 2 the safe edge IPR disk 1 is shown in the interproximal contact point 7 area wherein the dental handpiece 5 would rotate the safe edge IPR disk 1 which reduces the tooth or teeth 6 . FIG. 3 shows a safe edge IPR disk 1 with an axial center 8, planar surface 9 and an axial periphery 10. The safety edge IPR disk 1 has an abrasive coating 11 on the planar surface 9 which has an uncoated periphery 12. The uncoated periphery 12 makes the initial entry between the interproximal contact points 7 as shown in FIG. 2. In FIG. 4 the inside planar surface 13 of the safety edge IPR disk 1 faces the dental mandrel 2 and is coated with the abrasive coating 11. The safe edge IPR disk 1 in FIG. 4 would reduce the tooth closest to the powered dental handpiece 5. In FIG. 5 the outside planar surface 14 of the safe edge IPR disk 1 is on the side opposite the dental mandrel 2 and is coated with the abrasive coating 11.

The safe edge IPR disk 1 in FIG. 4 would reduce the tooth closest to the powered dental handpiece 5. The safe edge IPR disk 1 in FIG. 5 would reduce the tooth furthest away from the powered dental handpiece 5. In another embodiment both the inside 13 and the outside 14 planar surfaces 9 are coated with the abrasive 11. FIG. 6 shows a mesh safe edge IPR disk 20 wherein the safe edge IPR disk 20 is perforated 21. In FIG. 7 the safe edge IPR disk 1 and dental mandrel 2 are integral 22 wherein in an ideal form the metal is stainless steel and the abrasive coating 11 is diamond chips, allowing sterilizing in an autoclave. In another embodiment FIG. 8 discloses a screw 23 attachment between the safe edge IPR disk land the mandrel 2.

In a preferred embodiment the safety edge IPR disk 1 and mandrel are integral, the disk and mandrel are comprised of an autoclavable material, such as stainless steel, and the abrasive coating is made from diamond chips. The safe edge IPR disk 1 may also be made from a variety of other materials that would have the same physical characteristics as the stainless steel disk. In another preferred embodiment the safe edge IPR disk 1 is perforated 21. In a further preferred embodiment the dental mandrel 2 and safe edge IPR disk 1 are separate, joined by a screw 23,

FIG. 8, or a variety of quick-couples 24 as shown in FIG. 9.

The present invention has been described in specific embodiments, but there is no intention to limit the invention to these variations. The spirit of the invention provides a dental interproximal reduction disk with a smooth periphery which allows the disk to enter the interproximal contact points of adjacent teeth without notching the teeth.

I claim:

1. a safe edge IPR disk comprising:
a circular disk with an axial center, an axial periphery, an outside planar surface and an inside planar surface;
a rod-like mandrel with a driving end and a working end, the driving end adapted to be mounted to a powered dental handpiece and the working end attached at a right angle to the circular disk at the axial center of the inside planar surface; and
an abrasive coated on the planar surfaces of the circular disk extending from the disk axial center to an uncoated planar axial periphery wherein the uncoated periphery is the initial penetration when the circular disk is placed between the contact points of adjacent teeth.

2. The safety edge IPR disk of claim 1 is solid.

3. The safety edge IPR disk of claim 1 is perforated.

4. The safety edge IPR disk of claim 1 is integral with the rod-like mandrel.

5. The safety edge IPR disk of claim 1 is removably attached to the rod-like mandrel with a screw.

6. The safety edge IPR disk of claim 1 is removably attached to the rod-like mandrel with a quick-couple.

7. The safety edge IPR disk of claim 1 has the abrasive coating on the inside planar surface.

8. The safety edge IPR disk of claim 1 has the abrasive coating on the outside planar surface.

9. The safety edge IPR disk of claim 1 has abrasive coatings on the inside and outside planar surfaces.

10. The safety edge IPR disk of claim 1 wherein the safe edge IPR disk is 0.1 mm. thick.

11. a safe edge IPR disk comprising:
a circular disk with an axial center, an axial periphery, an outside planar surface and an inside planar surface;
a rod-like mandrel with a driving end and a working end, the driving end adapted to be mounted to a powered dental handpiece and the working end attached at a right angle to the circular disk at the axial center of the inside planar surface;
an abrasive coated on the planar surfaces of the circular disk extending from the disk axial center to an uncoated planar axial periphery wherein the uncoated periphery is the initial penetration when the circular disk is placed between the contact points of adjacent teeth; and; and
a perforated circular disk.

12. The safety edge IPR disk of claim 11 is integral with the rod-like mandrel.

13. The safety edge IPR disk of claim 11 is removably attached to the rod-like mandrel with a screw.

14. The safety edge IPR disk of claim 11 is removably attached to the rod-like mandrel with a quick-couple.

15. The safety edge IPR disk of claim 11 has the abrasive coating on the inside planar surface.

16. The safety edge IPR disk of claim 11 has the abrasive coating on the outside planar surface

17. The safety edge IPR disk of claim 11 has abrasive coatings on the inside and outside planar surfaces.

18. The safety edge IPR disk of claim 11 wherein the safe edge IPR disk is 0.1 mm. thick.

19. A method for polishing interproximal contact areas of adjacent teeth comprising the steps of:
providing a polishing device comprising (a) a disc-shaped body having a thickness of from about 0.1 to 0.7 millimeters wherein said body is adapted to be connected to a mandrel which is in turn attached to a driving means; and (b) an abrasive layer is coated on one side of the disk-shaped body except for an uncoated periphery;
driving said polishing device by a driving means; and
placing the uncoated periphery of the disk-shaped body into the interproximal contact area of adjacent teeth;
rotating the disk-shaped body;
penetrating the interproximal contact area until the abrasive layer contacts the tooth; and
polishing the interproximal area of the tooth,

20. A method for polishing interproximal contact areas of adjacent teeth as in claim 19 the disk-shaped body is coated on both sides and providing the additional step of polishing of adjacent teeth simultaneously.
